(19) United States
(12) Patent Application Publication
(10) Pub. No.: US 2006/0085557 A1
(43) Pub. Date: Apr. 20, 2006

(54) Method and apparatus for kernel-level passing of a data packet from a first data network to a second data network

(76) Inventor: Yoshihiro Ishijima, San Jose, CA (US)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/970,479

(22) Filed: Oct. 20, 2004

(51) Int. Cl. G06F 15/173

(52) U.S. Cl. 709/238

(57) ABSTRACT

Disclosed are a method and apparatus for passing a data packet from a first network to a second network at a kernel level. According to one illustrative embodiment, this is accomplished by receiving a data packet from a first network, storing the data packet in a kernel-space buffer, determining if the data packet needs to be directly passed to the second network and directing the data packet from the kernel-space buffer to the second network when the data packet needs to be directly passed to the second network.

### BACKGROUND

Networking structures often use various types of servers to complete a client-server connection. For example, a client-server connection can be made through a proxy server. A proxy server is a device that receives a client request from one of one or more client-capable devices and passes the client request onto a wide area network, e.g. the Internet. In this type of network structure, the proxy server adds value by causing client requests from two or more client-capable devices to appear as though they are coming from a single network address. In this way, several client-capable devices can share a single connection to the wide area network.

In another network structure, a load-balancer can be introduced between a connection to a wide area network and several servers. In this situation, several servers are made to appear to a client as a single server which can be accessed at a single network address. In this case, a client request is received from the wide area network and is routed to one of the servers behind the load-balancer.

A proxy server and a load-balancer are just two examples of specialized network processors that operate to facilitate the establishment of a connection between a client and a server. In a sense, these specialized network processors are “middle-men servers”. A middle-man server adds value in the grand scheme of networking, but such a middle-man server only facilitates a connection between a client and a server. As such, the value a middle-man server adds, although important, is not a primary service such as requesting a file (such as a client-capable device would do) or providing a file (such as sever would provide).

A specialized network processor has traditionally been implemented using specialized hardware and software. This, though, has caused such network processors to be more expensive, especially relative to high-volume hardware components like personal computers. Recognizing this, many network processors are now built on standard hardware platforms. When a standard hardware platform is used to implement a network processor, the standard hardware platform is generally still controlled by a resident operating system. The reason for this is based on the entire notion of “plug-n-play” hardware. For example, by using the resident operating system supplied with, or available for a particular hardware platform, standard peripheral components can be used by the network processor without the need for customized driver development. This is especially appealing when considering that vendors that provide a network interface peripheral will also generally provide a driver that enables the resident operating system to interact with the network interface.

By using the facilities provided by a resident operating system and by configuring a standard hardware platform for a custom application, the cost of a specialized network processor has been significantly reduced over the years. In a typical configuration, a personal computer is configured as a proxy server by including two network interface cards. The two network interface cards give the personal computer independent access to two data networks. In the proxy server application, one network is used as a local data network to which a plurality of client-capable devices can be communicatively attached. It should be appreciated that such attachment can be accomplished by way of a wired network or a wireless network.

Further describing this configuration, a resident operating system provides a protocol stack that uses specific drivers for each network interface card in order to provide network communications services to an application. In order to provide the proxy server functionality, an application is then executed under control of the resident operating system. The application, then, uses network communications services provided by the operating system to establish a connection with a client and then establish a connection with a server. The application executing under control of the operating system will then receive a data packet from the client and forward the data packet to the server. In this typical low-cost network processor structure, the application, which is called a “network processing application”, modifies some portion of the data packet as it passes it along from one data network to the other. Typically, the data does not need to be modified, but certain meta-data (e.g. header information) is often modified to affect the network processing function. For example, a network processing application that implements a proxy server function typically needs to change source and destination addresses and source and destination port numbers included in the header of a data packet.

Even though the cost of a network processor can be reduced by the use of standard hardware and an associated resident operating system, the use of the facilities usually provided by an operating system really limits the performance that can be achieved. For example, when a network processing application, which is executed under control of the resident operating system, need to pass a data packet from a first network interface card to a second network interface card, several memory transactions are required. First, when a data packet arrives at a first network interface card, a protocol stack receives the data packet into a memory buffer maintained by the operating system (i.e. a kernel-level buffer). This requires an allocation of a kernel-level buffer. The data packet then needs to be passed to the network processing application. Because the network processing application executes in application space, a new application-level buffer needs to be allocated and the data packet is copied from the kernel-level buffer to the application-level buffer. The network processing application can then operate on the data packet in application space. The network processing application then needs to pass the data packet back to the protocol stack. This requires allocation of a new kernel-level buffer before the data packet can be copied from the application-level buffer to the newly created kernel-level buffer. All of these data copying steps require processing power. Because the amount of processing power is limited, the number of data packets that can be processed in a given period of time is also limited.

### SUMMARY

Disclosed are a method and apparatus for passing a data packet from a first network to a second network at a kernel level. According to one illustrative embodiment, this is accomplished by receiving a data packet from a first network, storing the data packet in a kernel-space buffer, determining if the data packet needs to be directly passed to the second network and directing the data packet from the kernel-space buffer to the second network when the data packet needs to be directly passed to the second network.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for passing a data packet from a first data network to a second data network;

FIG. 2 is a flow diagram that depicts one example variation of the present method for receiving a data packet from a first network;

FIG. 3 is a flow diagram that depicts one alternative method for determining if a data packet needs to be directly passed to a second data network;

FIG. 4 is a flow diagram that depicts an alternative example method for directing a data packet to a second data network;

FIG. 5 is a flow diagram that depicts an alternative method for processing a data packet that does not need to be directed to a second data network;

FIG. 6 is a block diagram that illustrates one example embodiment of a network processor; and

FIG. 7 is a data flow diagram that depicts the internal operation of one example embodiment of a network processor.

### DETAILED DESCRIPTION

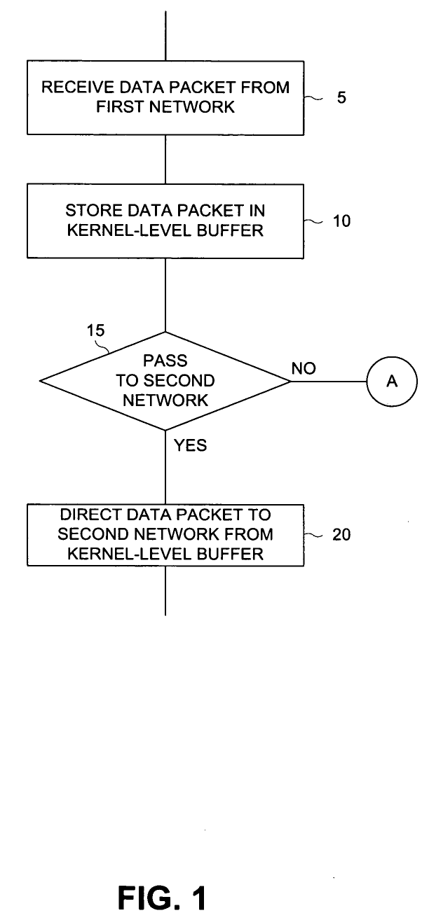

FIG. 1 is a flow diagram that depicts one example method for passing a data packet from a first data network to a second data network. According to this example method, passing of a data packet from a first data network to a second data network is accomplished at a kernel level. Accordingly, a data packet is received from a first network (step 5). The data packet is then stored in a kernel-level buffer (step 10). According to this example method, a determination is made as to whether or not the data packet should be forwarded to the second data network. When the data packet does need to be forwarded to the second data network (step 15), the data packet is directed from the kernel-level buffer to the second data network (step 20). The present method can be applied in situations where a computer system is configured to operate as a network processor. According to one illustrative use case, the present method is applied in a situation where a computer system is configured to operate as a load balancer. In another illustrative use case, the present method is applied in a situation where a computer system is configured as a proxy server. It should be appreciated that these are merely examples of how the present method can be applied in a situation where a computer system is configured to operate as a network processor. Accordingly, the scope of the claims appended hereto is not intended to be limited to any of the examples use cases presented herein.

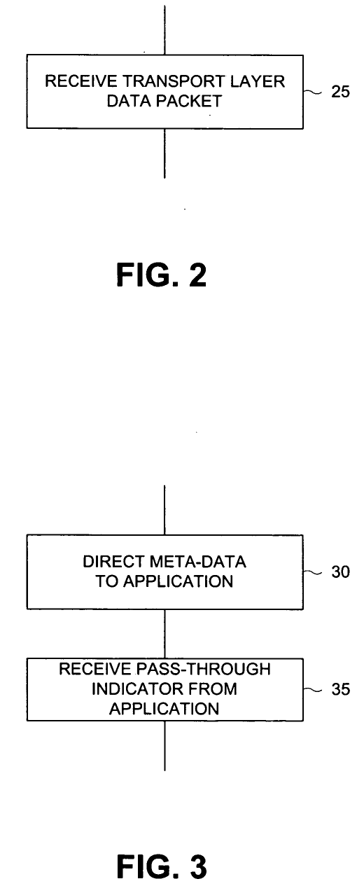

FIG. 2 is a flow diagram that depicts one example variation of the present method for receiving a data packet from a first network. According to this variation of the present method, a data packet is received from a first data network as a transport-layer data packet (step 25). It should be appreciated that, according to several illustrative use cases, processing of a data packet in a network processor is typically accomplished according to a protocol definition. Typically, processing of a data packet in a network processor requires the receipt of the data packet at a transport-layer as defined in the protocol definition. As such, a transport-layer data packet will typically include connection identification information that, according to this variation of the present method, is used to determine if a data packet needs to be forwarded to a second data network. For example, according to one popular communications protocol called the transport control protocol/Internet protocol (TCP/IP), connection identification information comprises a source address, a destination address, a source port number and a destination port number. Other information, such as a data packet sequence number, is also included in a header according to some communications protocol definitions. It should be appreciated that the present method can be applied irrespective of the type of communications protocol utilized on either one or both of the first and second data networks.

To reiterate, one feature of the present method provides for receiving a data packet from a first network at a level within a particular protocol wherein information in the header includes information that can be used to route the data packet. Accordingly, the present method relies on receiving meta-data that is associated with a data packet wherein the meta-data is used to determine whether or not the data packet is to be forwarded to the second data network. According to yet another variation of the present method, a connection identifier is one example of a type of meta-data that is used to determine if a data packet needs to be forwarded to a second data network. It should be further appreciated that the meta-data associated with a data packet, according to yet another variation of the present method, includes additional information that describes the type of data included in the data packet. For example, information that describes data included in the data packet as being voice over Internet protocol data is one example of other additional information that is used to determine whether or not a data packet should be forwarded to the second data network. A wide variety of other types of information can be used to determine whether or not a data packet is to be passed through to the second data network at any examples presented herein are not intended to limit the scope of the claims appended hereto. It should be further understood that any type of meta-data that is included along with or associated with a data packet and that can be used to facilitate routing of a data packet from a first data network to a second data network is to be included in the scope of the claims appended hereto.

FIG. 3 is a flow diagram that depicts one alternative method for determining if a data packet needs to be directly passed to a second data network. According to this alternative method, meta-data associated with a data packet is directed to an application (step 30) executing in application space. It should be appreciated that a data packet will have associated therewith some form of meta-data that, according to one variation of the present method, is used to determine if the data packet is to be forwarded to the second data network. Accordingly, the meta-data associated with the data packet is extracted from a kernel-level buffer used to store the data and its associated meta-data. An application executing in application space makes a determination, according to the meta-data associated with the data packet that it receives, as to whether or not the data packet is to be forwarded to the second data network. Accordingly, a pass-through indicator that reflects this determination is received from the application executing in the application space (step 35).

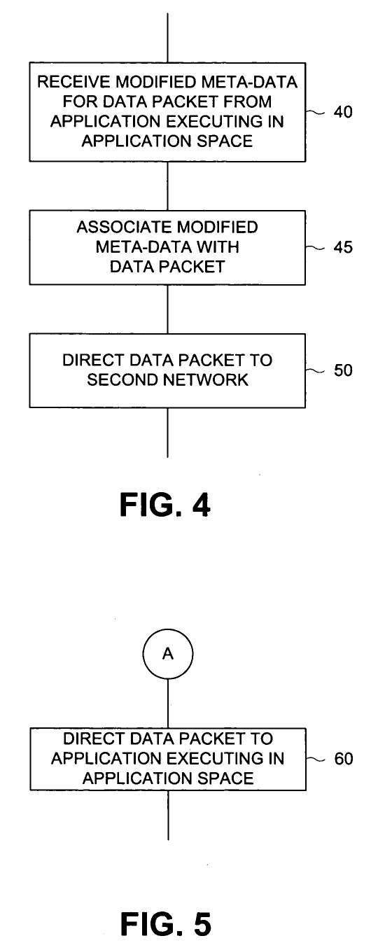

FIG. 4 is a flow diagram that depicts an alternative example method for directing a data packet to a second data network. An application that implements a network processing function will typically execute in an application space. Accordingly, the application space is typically managed by an operating system. According to various illustrative use cases, an application that is performing a network processing function will typically need to modify the meta data (e.g. a header) associated with a data packet received from the first data network before the data packet is subsequently forwarded to the second data network. According to the present method, the original meta-data and a data packet itself are stored in a kernel-level buffer. A modified meta-data, according to this variation of the present method, is received (step 40) from the application executing in application space. The modified meta-data is then associated with the data packet (step 45). This, according to yet another variation the present method, is accomplished by substituting the modified meta-data for the original meta-data stored in the kernel-level buffer. The data packet, together with the modified meta-data, is directed to the second data network (step 50).

FIG. 5 is a flow diagram that depicts an alternative method for processing a data packet that does not need to be directed to a second data network. According to the present method (as illustrated in FIG. 1), a determination is made as to whether or not a data packet needs to be forwarded to a second data network (step 15). In the event that a data packet does not need to be forwarded to a second data network, one present variation of the present method provides that the data packet itself is then directed to an application executing in application space (step 60). According to yet another variation of the present method, this is accomplished by providing a read-only reference to a kernel-level buffer used to store the data packet and, according to yet another variation of the present method, its associated meta-data.

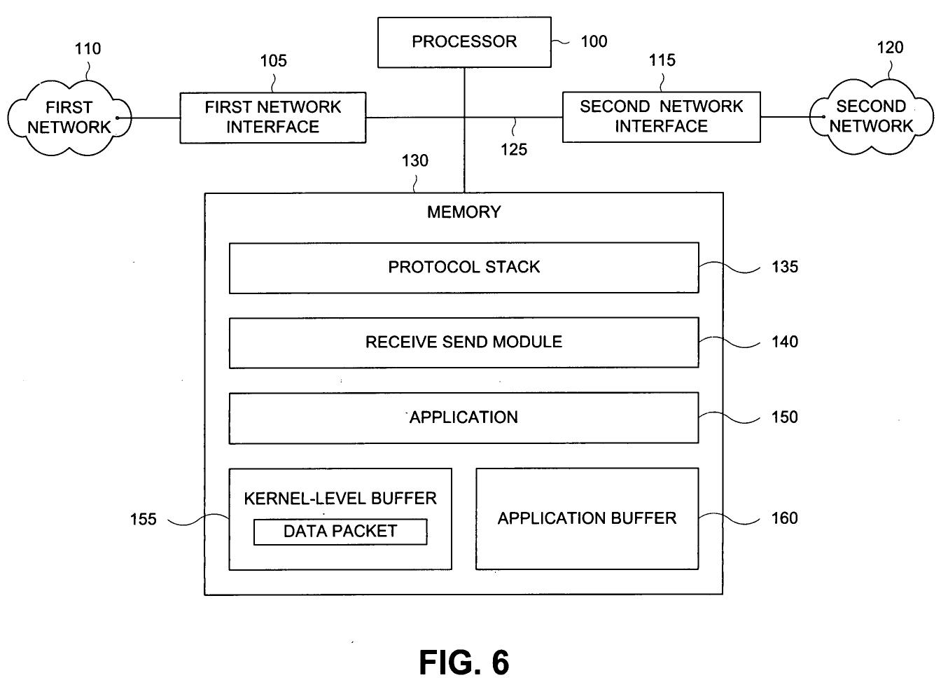

FIG. 6 is a block diagram that illustrates one example embodiment of a network processor. According to this example embodiment, a network processor comprises one or more processors 100, a first network interface 105, a second network interface 115 and a memory 130. All of these elements are communicatively coupled to each other by a bus 125.

According to this example embodiment, a network processor further comprises one or more functional modules stored in the memory 130. A functional module comprises an instruction sequence that is executed by one or more processors 100. As the processor 100 executes a particular instruction sequence, it performs certain functions commensurate with the teachings of the present method. The reader is advised that the term “minimally causes the processor” and variants thereof is intended to serve as an open-ended enumeration of functions performed by the processor 100 as it executes a particular functional module (i.e. instruction sequence). As such, an embodiment where a particular functional module causes the processor 100 to perform functions in addition to those defined in the appended claims is to be included in the scope of the claims appended hereto.

The functional modules (and their corresponding instruction sequences) described thus far enable passing of a data packet from a first data network to a second data network in accordance with the teachings of the present method. According to one illustrative embodiment, these functional modules are imparted onto computer readable medium. Examples of such medium include, but are not limited to, random access memory, read-only memory (ROM), Compact Disk (CD ROM), Digital Versatile Disks (DVD), floppy disks, and magnetic tape. This computer readable medium, which alone or in combination can constitute a stand-alone product, can be used to convert a general-purpose computing platform into a device capable of passing a data packet from a first data network to a second data network according to the techniques and teachings presented herein. Accordingly, the claims appended hereto are to include such computer readable medium imparted with such instruction sequences that enable execution of the present method and all of the teachings afore described.

Stored in the memory 130 are one or more functional modules including a protocol stack 135, a receive-send module 140 and an application 150. According to one alternative embodiment, the application 150 comprises a network processing application. According to yet another alternative embodiment, the application 150 comprises a proxy application. According to yet another alternative embodiment, the application 150 comprises a load balancing application. The memory 130 is also used to store a data packet. A data packet 170 is stored in a kernel-level buffer 155. According to yet another alternative embodiment, the memory 130 is also used to store a data packet in an application-level buffer 160. It should be further appreciated that, according to one alternative embodiment, a data packet includes meta-data and a data payload.

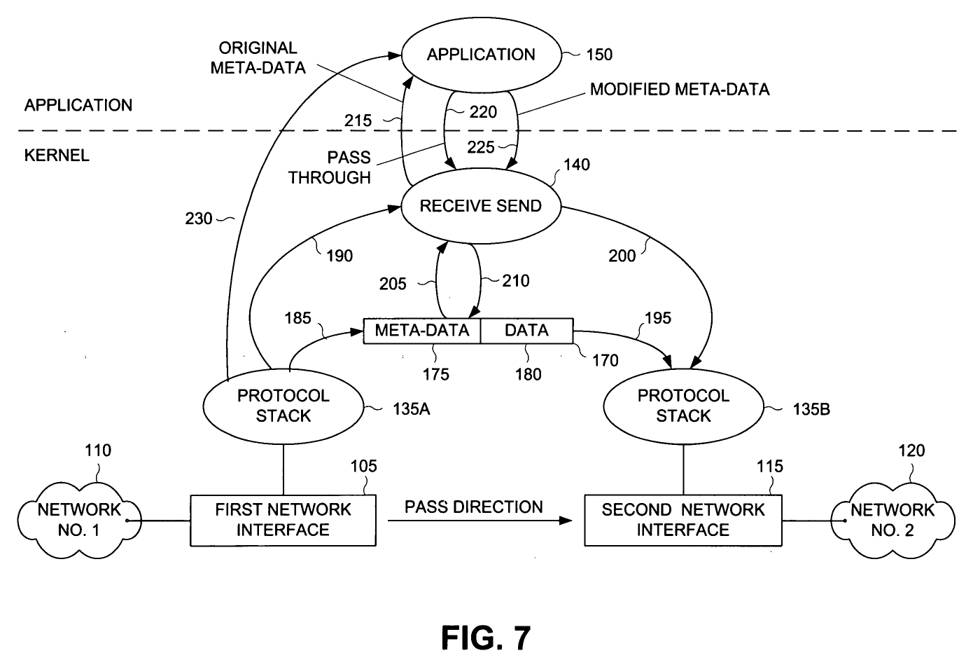

FIG. 7 is a data flow diagram that depicts the internal operation of one example embodiment of a network processor. According to this example embodiment, the processor 100 executes the receive-send module 140. The processor 100 also executes at least two instantiations of the protocol stack 135A, 135B. The first instantiation of the protocol stack 135A, when executed by the processor 100, minimally causes the processor 100 to receive a data packet from a first data network 110 by means of the first network interface 105. The second instantiation of the protocol stack 135B, when executed by the processor 100, minimally causes the processor 100 to convey a data packet to a second data network 120 by means of the second network interface 115.

As the processor 100 continues to execute the receive-send module 140, the receive-send module 140 minimally causes the processor 100 to accept 190 a data packet from a first instantiation of the protocol stack 135A executed by the processor 100. The data packet 170 is stored 185 in a kernel-level buffer. According to one alternative embodiment, the data packet includes meta-data 175 and payload data 180. The receive-send module 140, when executed by the processor 100, further minimally causes the processor 100 to direct 195 the data packet 170 from the kernel-level buffer to the second instantiation of the protocol stack 135B executed by the processor 100. According to one alternative embodiment, the processor 100 generates a transmit signal 200 that notifies the second instantiation of the protocol stack 135B that a data packet is to be conveyed from the kernel-level buffer to the second network 120. This results in the conveyance of the data packet to the second network 120 by means of the second network interface 115. According to one alternative embodiment, the protocol stack 135 causes the processor 100 to receive a data packet by minimally causing the processor 100 to receive a transport-layer data packet in accordance with the techniques and teachings of the present method.

According to one alternative embodiment, the receive-send module 140 causes the processor 100 to direct a data packet to the second instantiation of the protocol stack 135B by minimally causing the processor 100 to extract 205 a meta-data 175 from the data packet 170 stored in the kernel-level buffer. As the processor 100 continues to execute the receive-send module 140, it is further minimally caused to direct 215 the meta-data to an application 150 executing in application space. According to this alternative embodiment, the application 150 executing in application space, when executed by the processor 100, minimally causes the processor 100 to determine whether or not the data packet associated with a meta-data that it receives needs to be directed to a second data network 120. The result of this determination is reflected in a pass-through indicator 220 that is conveyed back to the receive-send module 140 as the processor 100 continues to execute the application 150 in application space. The receive-send module 140 directs the data packet 170 from the kernel-level buffer to the second instantiation of the protocol stack 135B when the pass-through indicator 220 indicates that the data packet stored in the kernel-level buffer needs to be directed to the second data network 120.

According to yet another alternative embodiment, the receive-send module 140, when executed by the processor 100, minimally causes the processor 100 to receive 225 a substitute (i.e. a modified) meta-data from the application 150 executing in application space. The modified meta-data is substituted 210 for the original meta-data 175 stored in the kernel-level buffer as the processor 100 continues to execute this alternative embodiment of a receive-send module 140. The data packet, which includes the modified meta-data 175 and the payload data 180, is directed to the second instantiation of the protocol stack 135B as the processor 100 continues to execute this alternative embodiment of a receive-send module 140. It should be appreciated that, according to one alternative embodiment, the meta-data comprises a protocol header. According to yet another alternative embodiment, the meta-data includes a source address, a destination address, a source port number and a destination port number.

In yet another illustrative alternative embodiment, the receive-send module 140, upon determining that a data packet stored in the kernel-level buffer does not need to be forwarded to a second data network 120, allows the application 150 to have access to the data packet stored in the kernel-level buffer. According to one alternative embodiment, this is accomplished when the processor 100 executes the first instantiation of the protocol stack 135A so as to provide 230 a read-only reference to the data packet 170 stored in the kernel-level buffer.

While the present method and apparatus has been described in terms of several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for passing a data packet from a first network to a second network at a kernel level comprising:
receiving a data packet from a first network;
storing the data packet in a kernel-space buffer;
determining if the data packet needs to be directly passed to the second network; and
directing the data packet from the kernel-space buffer to the second network when the data packet needs to be directly passed to the second network.

2. The method of claim 1 wherein receiving a data packet from a first network comprises receiving a transport layer data packet.

3. The method of claim 1 wherein determining if the data packet needs to be directly passed to a second network comprises:
directing a meta-data associated with the data packet to an application executing in application space; and
receiving a pass-through indicator from the application executing in application space.

4. The method of claim 1 wherein directing the data packet from the kernel space buffer to a second network when the data packet needs to be directly passed to the second network comprises:
receiving a modified meta-data for the data packet from an application executing in application space;
associating the modified meta-data with the data packet; and
directing the data packet and the associated modified meta-data to the second network.

5. The method of claim 1 further comprising directing the data packet to an application executing in application space when the data packet does not need to be passed to the second network.

6. A network processor comprising:
one or more processors;
first network interface capable of enabling a processor to communicate with a first data network;
second network interface capable of enabling a processor to communicate with a second data network;
memory capable of storing an instruction sequence and a kernel-level buffer;
one or more instruction sequences stored in the memory including:
protocol stack that, when a first instantiation of which is executed by the processor, minimally causes the processor to receive a data packet from the first network interface and that, when a second instantiation of which is executed by the processor, minimally causes the processor to convey a data packet to the second network interface;
receive-send module that, when executed by the processor, minimally causes the processor to:
accept a data packet from a first executing instantiation of the protocol stack so as to receive a data packet into a kernel-level buffer; and
direct the data packet from the kernel-level buffer to a second executing instantiation of the protocol stack when the data packet needs to be passed to a second data network.

7. The network processor of claim 6 wherein the protocol stack, when executed by the processor, causes the processor to receive a data packet by minimally causing the processor to receive a transport layer data packet.

8. The network processor of claim 6 wherein the receive-send module, when executed by the processor, causes the processor to direct the data packet from the kernel-level buffer to a second executing instantiation of the protocol stack by minimally causing the processor to:
extract a meta-data from the data packet stored in the kernel-level buffer;
direct the extracted meta-data to an application executing in application space;
receive a pass-through signal from the application executing in application space; and
direct the data packet to the second network interface when the pass-through signal indicates that the data packet is to be passed to the second network interface.

9. The network processor of claim 6 wherein the receive-send module, when executed by the processor, causes the processor to direct the data packet from the kernel-level buffer to a second executing instantiation of the protocol stack by minimally causing the processor to:
receive into the kernel-level buffer a modified meta-data for the data packet from an application executing in application space; and
direct the data packet and the modified meta-data to the second network interface.

10. The network processor of claim 6 wherein the receive-send module, when executed by the processor, causes the processor to further minimally provide to an application executing in application space a reference to the kernel-level buffer when the data packet does not need to be directed to the second network interface.

11. A computer readable medium having imparted thereon one or more instruction sequences for passing a data packet from a first data network to a second data network including:
receive-send module that, when executed by a processor, minimally causes a processor to:
accept a data packet from a first executing instantiation of a protocol stack so as to receive a data packet into a kernel-level buffer; and
direct the data packet from the kernel-level buffer to a second executing instantiation of a protocol stack when the data packet needs to be passed to a second data network.

12. The computer readable medium of claim 11 wherein the protocol stack, when executed by a processor, causes a processor to receive a data packet by minimally causing a processor to receive a transport layer data packet.

13. The computer readable medium of claim 11 wherein the receive-send module, when executed by a processor, causes a processor to direct the data packet from the kernel-level buffer to a second executing instantiation of the protocol stack by minimally causing a processor to:
extract a meta-data from the data packet stored in the kernel-level buffer;
direct the extracted meta-data to an application executing in an application space;
receive a pass-through signal from the application executing in the application space; and
direct the data packet to the second network interface when the pass-through signal indicates that the data packet is to be passed to the second network interface.

14. The computer readable medium of claim 11 wherein the receive-send module, when executed by a processor, causes a processor to direct the data packet from the kernel-level buffer to a second executing instantiation of the protocol stack by minimally causing a processor to:
receive into the kernel-level buffer a modified meta-data for the data packet from an application executing in application space; and
direct the data packet and the modified meta-data to the second network interface.

15. The computer readable medium of claim 11 wherein the receive-send module, when executed by a processor, causes a processor to further minimally provide to an application executing in an application space a reference to the kernel-level buffer when the data packet does not need to be directed to the second network interface.

16. A network processor comprising:
means for receiving a data packet from a first network; and
means for directing the data packet directly to a second network when the data packet needs to be directly passed to the second network.

17. The network processor of claim 16 wherein the means for receiving a data packet from a first network comprises:
means for receiving information from a first network medium;
means for assembling the received information as a data packet; and
means for storing the data packet at a kernel-level.

18. The network processor of claim 16 wherein the means for directing a data packet to a second network comprises:
means for determining when a data packet needs to be directed to a second data network; and
means for directing a data packet stored at a kernel level to a second network medium when the data packet needs to be directed to a second data network.

19. The network processor of claim 18 wherein the means for determining when a data packet needs to be directed to a second data network comprises:
means for examining a meta-data portion of a data packet; and
means for generating a pass-through indication according to the examined meta-data.

20. The network processor of claim 18 wherein the means for directing a data packet from a kernel level to a second data network when a data packet needs to be directed to a second data network comprises:
means for modifying a meta-data portion of a data packet; and
means for directing the data packet and the modified meta-data to a second network medium.
